(19) United States
(12) Patent Application Publication
(10) Pub. No.: US 2013/0083444 A1
(43) Pub. Date: Apr. 4, 2013

(54) METHOD AND APPARATUS FOR RELAY CONTROL

(71) Applicant: Enphase Energy, Inc., Petaluma, CA (US)

(72) Inventors: Andrew Barnes, Santa Rosa, CA (US); Eric K. Zimmerman, Sebastopol, CA (US)

(73) Assignee: Enphase Energy, Inc., Petaluma, CA (US)

(21) Appl. No.: 13/644,665

(22) Filed: Oct. 4, 2012

Related U.S. Application Data
(60) Provisional application No. 61/543,062, filed on Oct. 4, 2011.

(51) Int. Cl. H01H 47/02

(52) U.S. Cl. 361/211

(57) ABSTRACT

A method and apparatus for controlling an electromechanical relay. In one embodiment, the method comprises reducing a relay current of a relay that is activated, determining a first value of the relay current, wherein the first value is either a minimum default current value or a value of the relay current at which the activated relay deactivates, and determining a holding current value for maintaining the relay in an activated state, wherein the holding current value is at least the first value and less than a second value of the relay current at which the relays activates.

### CROSS-REFERENCE TO RELATED APPLICATIONS

This application claims benefit of U.S. provisional patent application Ser. No. 61/543,062, filed Oct. 4, 2011, which is herein incorporated in its entirety by reference.

### BACKGROUND OF THE INVENTION

1. Field of the Invention

Embodiments of the present disclosure relate generally to electromechanical relays, and, in particular, to efficiently operating an electromechanical relay.

2. Description of the Related Art

Relays are commonly used devices to provide control of current flow in a circuit. Often relays comprise a coil through which a current passes to generate an electromagnetic field that attracts a magnetic armature member to either open or close the relay. One type of relay, known as a normally open (NO) relay, employs a normally open armature and requires a sufficient activation current in order to close the relay. As a result of the inertia that must be overcome and the frictional forces involved, the level of current required to move the armature from the normally open position will be greater than the level of current required to maintain the armature in a closed position once it closes, resulting in reduced efficiency if the same level of current is used to both close the relay and maintain the closed relay.

Therefore, there is a need in the art for a method and apparatus for efficiently operating a relay.

### SUMMARY OF THE INVENTION

Embodiments of the present invention generally relate to a method and apparatus for controlling an electromechanical relay. In one embodiment, the method comprises reducing a relay current of a relay that is activated, determining a first value of the relay current, wherein the first value is either a minimum default current value or a value of the relay current at which the relay deactivates, and determining a holding current value for maintaining the relay in an activated state, wherein the holding current value is at least the first value and less than a second value of the relay current at which the relay activates.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a relay-controlled system in accordance with one or more embodiments of the present invention;

FIG. 2 is a block diagram of a controller in accordance with one or more embodiments of the present invention;

FIG. 3 is a flow diagram of a method for operating a relay in accordance with one or more embodiments of the present invention; and

FIG. 4 is a block diagram of a system for generating power in accordance with one or more embodiments of the present invention.

### DETAILED DESCRIPTION

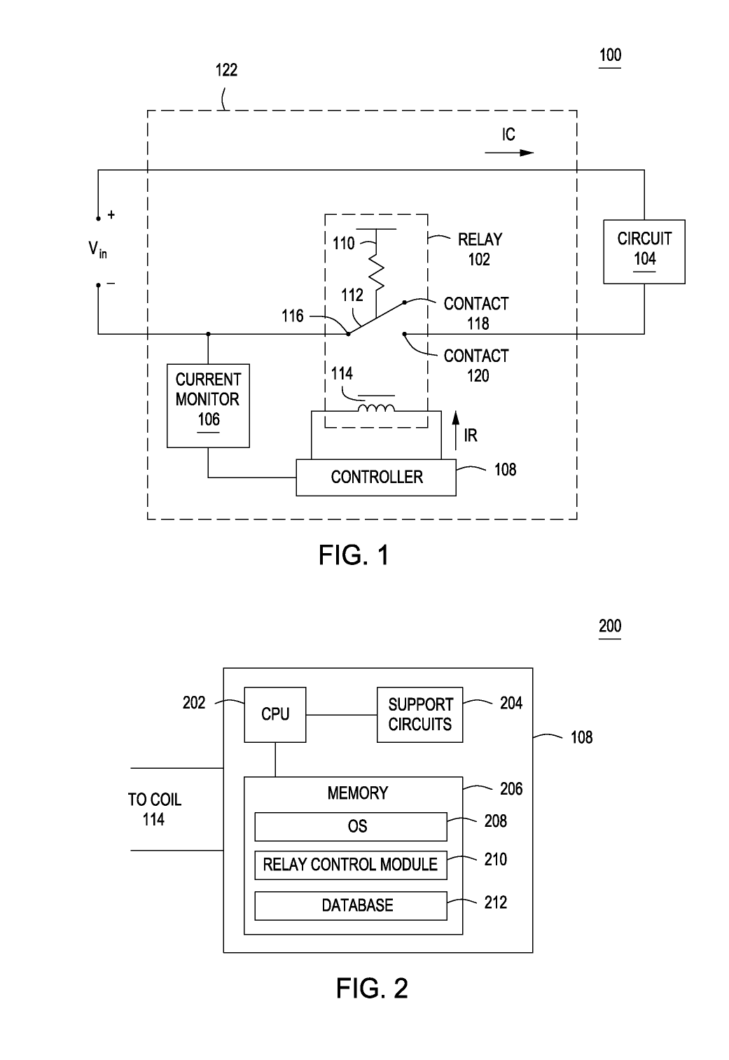

FIG. 1 is a block diagram of a relay-controlled system 100 in accordance with one or more embodiments of the present invention. The relay-controlled system 100 (“system 100”) comprises a relay 102 serially coupled between an input voltage Vin and a circuit 104. The relay 102 is a normally open (NO) electromechanical relay comprising a spring 110, an armature 112, and a coil 114. The armature 112 is a movable magnetic member having a hinged terminal 116 coupled to a terminal of the input voltage Vin. When closed, a contact 118, located at the opposing end of the armature 112 from the hinged terminal 116, makes contact with a contact 120 coupled to the circuit 104. As such, when the armature 112 is open (i.e., when there is no contact between contacts 118 and 120) current cannot flow to the circuit 104, and when the armature 112 is closed (i.e., when there is contact between contacts 118 and 120) a current Ic may flow to the circuit 104.

The spring 110 is anchored at one end and coupled at the other end to the armature 112. When the spring 110 has no force applied to it and is unstretched, the spring 110 maintains the armature 112 in the normally open position such there is no contact between the contacts 118 and 120 and no current can flow to the circuit 104.

The armature 112 may be formed from or comprises a magnetic material, such as ferromagnetic materials nickel, iron, and the like. The coil 114 is coupled across the controller 108 and is electromagnetically coupled to the armature 112 as a result of a current Ir through the coil 114. The controller 108 controls the current Ir through the coil 114 for opening and closing the relay 102. When a sufficient level of current Ir (i.e., an activation level) flows through the coil 114, the coil 114 becomes energized and attracts the armature 112, extending the spring 110 until there is contact between the contacts 118 and 120. The relay 102 is thereby closed, and current may flow to the circuit 104.

The current monitor 106 is coupled between the relay 102 and the negative terminal of the voltage Vin for sampling the current Ic through the relay 102 and generating values indicative of the sampled current Ic (“current samples”). In some embodiments, the circuit 104 may be coupled to a commercial power grid, and the current sampling may be performed once per line cycle (e.g., at 60 Hz) at the zero crossing of the line voltage. In other embodiments, other sampling rates and/or points may be used. In some embodiments, the current monitor 106 comprises an analog-to-digital converter (ADC) for generating the current samples in a digital format. The current monitor 106 couples the current samples to the controller 108 to indicate the level of current Ic flowing through the closed armature 112. The controller 108 may then utilize such current samples to determine whether the armature 112 is open or closed, and at what current level the relay 102 deactivates.

In some embodiments, the current monitor 106 samples Ic when purely reactive current is flowing; i.e., no resistive power losses are incurred as the current and voltage are 90 degrees out of phase. In such embodiments, a change in the reactive current indicates whether the relay 102 is open or closed (e.g., in an embodiment where the circuit 104 is a power inverter, whether the inverter is producing power or not). An increase in reactive current indicates that the relay 102 has been closed (e.g., extra capacitance has been switched into the circuit). In some alternative embodiments, resistive current may be measured in addition to or in place of reactive current. In general, the controller 108 determines whether a change in current has occurred as an indication of whether the relay 102 is open or closed, although in some embodiments zero current flow may additionally or alternatively be utilized to indicate when the relay 102 is open.

The armature 112 remains closed as long as a sufficient level of current Ir (i.e., a holding level) flows through the coil 114. When the current Ir becomes low enough, the coil 114 becomes insufficiently energized to maintain the armature 112 in a closed position; at such time, the mechanical force of the spring 110 exceeds the electromagnetic force on the armature 112 and the spring 110 contracts, pulling the armature 112 away from the coil 114 and breaking contact between the contacts 118 and 120 to stop current flow to the circuit 104.

In accordance with one or more embodiments of the present invention, the system 100 self-determines a value for a holding current (i.e., a level of holding current to be generated) such that the holding current is less than the activation current and still maintains the armature 112 in a closed position. In order to determine such a minimum holding current value, the controller 108 generates the current Ir at the activation level to close the armature 112. Once the armature 112 is closed, the controller 108 ramps down (i.e., decreases) the current Ir through the coil 114 until the armature 112 opens. Based on the value of current Ir at which the armature 112 opens, the controller 108 determines a value for the minimum holding current that will maintain the armature 112 in a closed position. In some embodiments, the controller 108 computes the minimum holding current value by adding a nominal amount, for example 10% of the closing (or activation) current value, to the current value at which the armature 112 opens. The controller 108 may then store the minimum holding current value and generate the current Ir through the coil 114 at such a level during periods of operating the relay 102 when the armature 112 is to remain closed. In some embodiment, the current Ir is reduced until either the armature 112 opens or the current Ir reaches a default minimum holding current setpoint, whichever occurs first. If the default minimum holding current setpoint is reached before the armature 112 opens, it is used as the minimum holding current value. Such operation allows the controller 108 to generate a holding current that is less than the activation current without requiring the relay 102 to deactivate. The default minimum holding current setpoint may be determined by increasing the holding current at which the relay 102 opens (i.e., the opening current) by, for example, 10%. Generally, several relays may be sampled to obtain an average opening current.

In some embodiments, the minimum holding current value may be automatically adjusted in response to external circumstances that cause the armature 112 to open even though the determined minimum holding current flows through the coil 114. For example, vibrations occurring near the system 100 may cause the armature 112 to open prematurely. As a result of such armature deactivation, the minimum holding current value may be increased by some amount, such as 10% of the closing (or activation) current value, and the modified holding current value may then be stored for subsequent use.

The relay 102, current monitor 106, and controller 108 form a relay system 122 for controlling current flow to the circuit 104. In some embodiments, the activating/deactivating of the relay 102 for determining the minimum holding current value may occur during part of the normal operation of the circuit 104; i.e., the relay 102 is activated as part of normal operation of the circuit 104 and, when the relay 102 is to be deactivated as part of normal operation of the circuit 104, the current is ramped down until the relay 102 opens. In other embodiments, the relay activation/deactivation may be driven specifically to determine a minimum holding current value; i.e., the relay 102 is activated and, immediately following activation, the current Ir is reduced until the relay 102 opens. Subsequently, the relay 102 may be activated/deactivated as part of normal operation for the circuit 104.

By self-determining the minimum holding current value, the system 100 may operate to keep the relay 102 activated as needed without utilizing an unnecessarily high relay current Ir. Further, the self-determined minimum holding current value is tailored to the particular relay 102; as such, the minimum holding current value may be determined independent of differences among relays, manufacturing defects in relays, changes during operation, and the like.

In some embodiments, such as the embodiment depicted in FIG. 1 and described above, the relay 102 is a normally open (NO) relay that requires an activation current to close. In other embodiments, the relay 102 may be a different type of relay that requires an activation current to activate the relay and a holding current to maintain the relay in an activated state, such as a normally closed (NC) relay that requires an activation current in order to open from a normally closed position and a holding current to maintain the relay in an open position.

FIG. 2 is a block diagram of a controller 108 in accordance with one or more embodiments of the present invention. The controller 108 may be comprised of hardware, software, or a combination thereof, and comprises support circuits 204 and a memory 206, each coupled to a central processing unit (CPU) 202. The CPU 202 may comprise one or more conventionally available processors, microprocessors, microcontrollers and combinations thereof configured to execute non-transient software instructions to perform various tasks in accordance with the present invention. The CPU 202 may additionally or alternatively include one or more application specific integrated circuits (ASICs). The support circuits 204 are well known circuits used to promote functionality of the CPU 202. Such circuits include, but are not limited to, a cache, power supplies, clock circuits, buses, input/output (I/O) circuits, and the like. The controller 108 may be implemented using a general purpose computer that, when executing particular software, becomes a specific purpose computer for performing various embodiments of the present invention.

The memory 206 may comprise random access memory, read only memory, removable disk memory, flash memory, and various combinations of these types of memory. The memory 206 is sometimes referred to as main memory and may, in part, be used as cache memory or buffer memory. The memory 206 generally stores the operating system (OS) 208, if necessary, of the controller 108 that can be supported by the CPU capabilities. In some embodiments, the OS 208 may be one of a number of commercially available operating systems such as, but not limited to, Linux, Real-Time Operating System (RTOS), and the like.

The memory 206 stores non-transient processor-executable instructions and/or data that may be executed by and/or used by the CPU 202. These processor-executable instructions may comprise firmware, software, and the like, or some combination thereof.

The memory 206 may store various forms of application software, such as a relay control module 210 for performing functions related to the present invention. For example, the controller 108 executes the relay control module 210 to determine the minimum holding current value as previously described. The controller 108 may also execute the relay control module 210 to adjust the minimum holding current value as needed; to store the minimum holding current value; and to generate the relay current Ir at a particular level, such as the minimum holding current level during periods when the armature 112 is to remain closed.

The memory 206 may additionally store a database 212 for storing data related to the present invention, such as the minimum holding current value, one or more default minimum holding current setpoints, and the like.

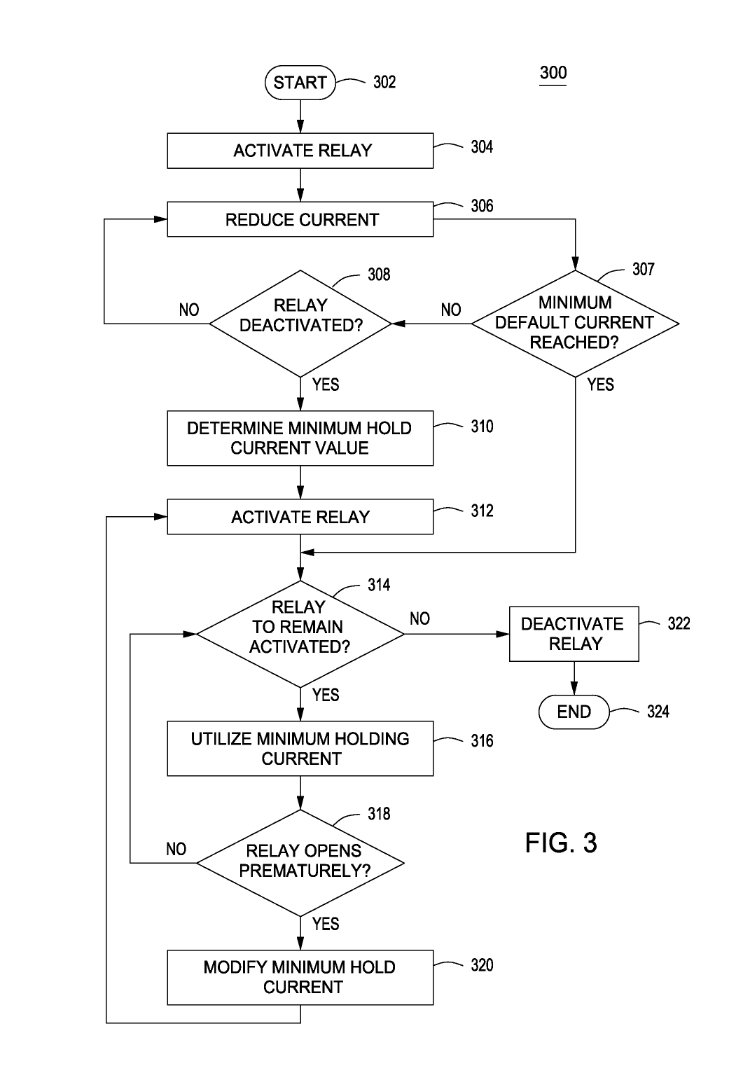

In other embodiments, the CPU 202 may be a microcontroller comprising internal memory for storing controller firmware that, when executed, provides the controller functionality for controlling the relay 102, for example as described below with respect to FIG. 3.

FIG. 3 is a flow diagram of a method 300 for operating a relay in accordance with one or more embodiments of the present invention. The method 300 represents one embodiment of an implementation of the relay control module 210. In some embodiments, such as the embodiment described below, a normally open (NO) relay may be used as a make-or-break switch for controlling current flow to a circuit (e.g., the relay 102 of the system 100). In some alternative embodiments, the relay may be a normally closed (NC) type of relay, or any type of relay that requires an activation current and a holding current.

The method 300 starts at step 302 and proceeds to step 304. At step 304, the relay is activated by generating an activation current through a coil of the relay and causing the relay armature to close. The method 300 proceeds to step 306, where the level of current through the relay coil is incrementally decreased, for example in steps of 10% of the maximum closing (or activation) current value. At step 307, a determination is made whether a default minimum holding current setpoint has been reached. In some embodiments, the default minimum holding current setpoint is a predetermined value which may be determined by sampling several relays to determine an average opening current and increasing the average opening current by, for example, 10%. If the result of the determination at step 307 is yes, that the default minimum holding current setpoint has been reached, the default minimum holding current setpoint is used as the minimum holding current value and the method 300 proceeds to step 314. If the result of the determination at step 307 is no, that the default minimum holding current setpoint has not been reached, the method 300 proceeds to step 308.

At step 308, a determination is made whether the relay has opened. In some embodiments, such a determination may be made based on current samples from a current monitor sampling the current through the relay armature, e.g., as previously described above with respect to FIG. 1. If the result of the determination at step 308 is no, i.e., that the relay has not opened, the method 300 returns to step 306. If the result of the determination at step 308 is yes, i.e., that the relay has opened, the method 300 proceeds to step 310.

At step 310, a minimum holding current value required to keep the relay closed is determined. The minimum holding current value may be computed by adding a nominal value to the value of current through the relay coil at which the relay opens. In some embodiments, the minimum holding current value may be determined by adding a nominal value, such as 10% of the closing (or activation) current value, to the current value that causes the relay to open; alternatively, the previous value at which the relay was measured to be still closed may be set as the minimum holding current value. The determined minimum holding current value may be then stored for subsequent use. In some embodiments, the activating/deactivating of the relay for determining the minimum holding current value may be part of the normal operation of the coupled circuit; i.e., the relay is activated as part of normal operation of the circuit, and, when the relay is to be deactivated as part of normal operation of the circuit, the current is ramped down until the relay opens. In such embodiments, the rate at which the current is decreased may be based upon how rapidly the relay must be deactivated. In other embodiments, the relay activation/deactivation may occur specifically to determine the minimum holding current value; i.e., the relay is activated and, immediately following activation, the current is reduced until the relay opens. The method 300 proceeds to step 312, where the relay is activated as needed to allow current to flow through the coupled circuit.

At step 314, a determination is made whether the relay needs to remain activated. If the result of such determination is yes, the method 300 proceeds to step 316 where the current through the relay coil is generated per the minimum holding current value. By generating the relay current at such a value, the relay is able to remain closed without utilizing an unnecessarily high relay current. The method 300 proceeds to step 318.

At step 318 a determination is made whether the relay opens prematurely. For example, nearby vibrations may cause the relay to open while the minimum holding current is flowing through the relay coil to keep the relay closed. If the result of the determination at step 318 is no, the method 300 returns to step 314. If the result of the determination at step 318 is yes, the relay proceeds to step 320. At step 320, the minimum holding current value is modified in order to obtain a new minimum holding current value that will result in the relay remaining closed, for example, when external vibrations occur. The new minimum holding current value may be obtained by adding a value, such as 10% of the relay closing (or activation) current value to the previous minimum holding current value. The new minimum holding current value is subsequently used for maintaining the relay in a closed position as needed. The method 300 returns to step 312 where the relay is reactivated.

If the result of the determination at step 314 is no, the method 300 proceeds to step 322 where the relay is deactivated. The method 300 then proceeds to step 324 where it ends.

By self-determining a minimum holding current value as described above, the relay may be held closed as needed without utilizing an unnecessarily high relay current. Additionally, the minimum holding current value determined is specific to the individual relay and is independent of differences among relays, manufacturing defects in relays, changes during operation, and the like.

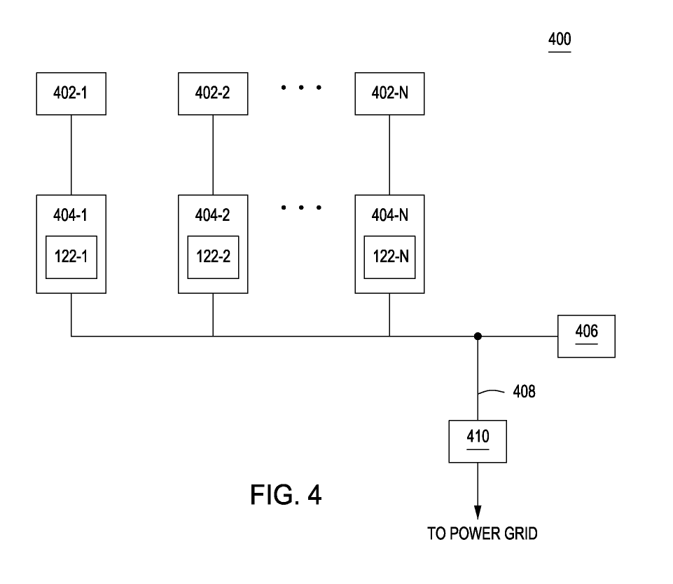

FIG. 4 is a block diagram of a system 400 for generating power in accordance with one or more embodiments of the present invention. This diagram only portrays one variation of the myriad of possible system configurations and devices that may utilize the present invention. The present invention can be utilized in any system or device requiring a relay that utilizes an activation current and a holding current, such as DC/DC converters, DC/AC inverters, or the like. In some embodiments, such as the embodiment described below, the system 400 comprises a plurality of DC/AC inverters for inverting DC power, received from solar photovoltaic (PV) modules, to AC power. In other embodiments, the system 400 may comprise DC/DC converters, rather than DC/AC inverters, for converting the received solar energy to DC power; additionally or alternatively, the system may convert DC power from other DC power sources, such as other types of renewable energy sources (e.g., wind, hydroelectric, or the like), batteries, and the like.

The system 400 comprises a plurality of inverters 404-1, 404-2 . . . 404-N, collectively referred to as inverters 404; a plurality of PV modules 402-1, 402-2 . . . 402-N, collectively referred to as PV modules 402; a power conversion system controller 406; an AC bus 408; and a load center 410.

Each inverter 404-1, 404-2 . . . 404-N is coupled to a PV module 402-1, 402-2 . . . 402-N, respectively, in a one-to-one correspondence. The inverters 404 are further coupled to the power conversion system controller 406 via the AC bus 408. The power conversion system controller 406 is capable of communicating with the inverters 404 for providing operative control of the inverters 404. In some embodiments, the power conversion system controller 406 may be a monitor for monitoring the inverters 404; additionally or alternatively, the power conversion system controller 406 may be a networking hub for communicatively coupling the inverters 404 to the Internet. The inverters 404 are also coupled to the load center 410 via the AC bus 408.

The inverters 404 convert DC power generated by the PV modules 402 to commercial power grid compliant AC power and couple the AC power to the load center 410. The generated AC power may be further coupled from the load center 410 to the one or more appliances and/or to a commercial power grid. Additionally or alternatively, generated energy may be stored for later use; for example, the generated energy may be stored utilizing batteries, heated water, hydro pumping, H₂O-to-hydrogen conversion, or the like. In some embodiments, each inverter 404 may have a DC/DC converter coupled between the inverter 404 and the corresponding PV module 402. Additionally or alternatively, the PV modules 402 may all be coupled to a single inverter 404 for inverting the DC power to AC power (i.e., a centralized DC/AC inverter).

Each of the inverters 404 comprises a relay system 122 (i.e., the inverters 404-1, 404-2 . . . 404-N comprise the relay systems 122-1, 122-2 . . . 122-N, respectively). For example, each relay system 122 may be used as a galvanic safety isolation disconnect between an AC output of the corresponding inverter 404 and the AC grid. This disconnect prevents the flow of current or voltage if the inverter 404 or the grid is in an abnormal condition. Each of the relay systems 122 determines and utilizes a minimum holding current value, as previously described, during operation of the relay system 122. In some embodiments, the relay systems 122 determine their corresponding minimum holding current levels daily upon activation of the inverters 404. For example, upon start-up each morning, each relay system 122 may operate as described above with respect to the method 300 in order to determine its minimum holding current level, which then may be stored in a memory, such as a random access memory (RAM) (e.g., the memory 206), for use while the corresponding inverter 404 remains active during the day.

In some embodiments, the relay system controller (i.e., controller 108 of the relay system 122) may be part of a controller for the corresponding inverter 404, e.g., an inverter controller for controlling the inverter power conversion. In other embodiments, the relay system 122 may be coupled to the inverter 404 but not part of the inverter 404.

The foregoing description of embodiments of the invention comprises a number of elements, devices, circuits and/or assemblies that perform various functions as described. For example, the controller 108 is one example of a means for reducing a relay current of a relay that is activated, a means for determining a first value of the relay current at which the relay deactivates, and a means for determining a holding current value for maintaining the relay in an activated state once activated. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is determined by the claims that follow.

1. A method of controlling an electromechanical relay, comprising:
reducing a relay current of a relay that is activated;
determining a first value of the relay current, wherein the first value is either a minimum default current value or a value of the relay current at which the relay deactivates; and
determining a holding current value for maintaining the relay in an activated state, wherein the holding current value is at least the first value and less than a second value of the relay current at which the relay activates.

2. The method of claim 1, wherein the holding current value is equal to the first value plus a nominal value.

3. The method of claim 2, wherein the nominal value is on the order of 10% of the second value.

4. The method of claim 1, wherein the relay is a normally open relay.

5. The method of claim 1, wherein the relay is a normally closed relay.

6. The method of claim 1, wherein the first value is determined based on a change in reactive current.

7. The method of claim 1, further comprising increasing the holding current value subsequent to the relay deactivating while being maintained in the activated state by current at the holding current value.

8. An apparatus for controlling an electromechanical relay, comprising:
a controller for (i) reducing a relay current of a relay that is activated, (ii) determining a first value of the relay current, wherein the first value is either a minimum default current value or a value of the relay current at which the relay deactivates, and (iii) determining a holding current value for maintaining the relay in an activated state, wherein the holding current value is at least the first value and less than a second value of the relay current at which the relay activates.

9. The apparatus of claim 8, the holding current value is equal to the first value plus a nominal value.

10. The apparatus of claim 9, wherein the nominal value is on the order of 10% of the second value.

11. The apparatus of claim 8, wherein the relay is a normally open relay.

12. The apparatus of claim 8, wherein the relay is a normally closed relay.

13. The apparatus of claim 8, wherein the first value is determined based on a change in reactive current.

14. The apparatus of claim 8, wherein the controller further increases the holding current value subsequent to the relay deactivating when being maintained in an activated state by current at the holding current value.

15. A system for controlling an electromechanical relay, comprising:
a relay; and
a controller, coupled to the relay, for (i) reducing a relay current of the relay when it is activated, (ii) determining a first value of the relay current, wherein the first value is either a minimum default current value or a value of the relay current at which the relay deactivates, and (iii) determining a holding current value for maintaining the relay in an activated state, wherein the holding current value is at least the first value and less than a second value of the relay current at which the relay activates.

16. The system of claim 15, wherein the holding current value is equal to the first value plus a nominal value on the order of 10% of the second value.

17. The system of claim 15, wherein the relay is a normally open relay.

18. The system of claim 15, wherein the relay is a normally closed relay.

19. The system of claim 15, wherein the first value is determined based on a change in reactive current.

20. The system of claim 15, wherein the controller further increases the holding current value subsequent to the relay deactivating when being maintained in an activated state by current at the holding current value.
